(19) United States
(12) Patent Application Publication
(10) Pub. No.: US 2026/0258675 A1
(43) Pub. Date: Sep. 3, 2026

(54) Multi-drawer Cabinet Locking Mechanism

(71) Applicant: CEHA BURO MOBILYALARI ANONIM SIRKETI, KAYSERI (TR)

(72) Inventor: Cetin SEN, KAYSERI (TR)

(73) Assignee: CEHA BURO MOBILYALARI ANONIM SIRKETI, KAYSERI (TR)

(21) Appl. No.: 19/183,954

(22) Filed: Apr. 21, 2025

(30) Foreign Application Priority Data
Feb. 28, 2025 (TR) 2025/002495

(51) Int. Cl. E05B 65/463

(52) U.S. Cl. CPC E05B 65/463

(57) ABSTRACT

A cabinet locking mechanism is used in multi-drawer cabinets with multiple drawers, both side by side and on top of each other, which ensures that when one of the drawers in the same row is open, the other drawers above and below are locked. The cabinet locking mechanism includes a locking tongue, a locking, a bearing plate shaft, a locking and guiding element, a drawer lock plate, a locking latch, a blocking plate and a blocking buffer consisting of an upper buffer and a lower buffer.

### CROSS REFERENCE TO THE RELATED APPLICATIONS

This application is based upon and claims priority to Turkish patent application No. TR2025/002495, filed on February 28, 2025, the entire contents of which are incorporated herein by reference.

### TECHNICAL FIELD

The present invention generally relates to locking mechanisms used in drawer cabinets.

In particular, the present invention relates to a cabinet locking mechanism for use in multi-drawer cabinets with multiple drawers, both side by side and on top of each other, which ensures that when one of the drawers in the same row is open, the other drawers above and below are locked.

### BACKGROUND

Nowadays, in areas such as repair shops and offices, cabinets with multiple drawers, side by side or on top of each other, are used to store both repair shop tools and office documents and supplies. For security reasons, the drawers in these cabinets are locked when not in use.

In the drawer cabinets of the state of the art, the locking system is located on the top right or top left of the cabinet, and only the drawers underneath can be opened if the lock is unlocked. In cabinets with a central lock, a locking system is created in a single row on both sides of the drawer or at the back. In both cases, a separate lock and associated locking system must be used for drawers with different pitches located side by side.

In the current state of the art, in models where the lock is in the center, the lock mechanism is stiff and noisy. For this reason, in narrow and wide drawer cabinets, loud noises are heard in the locking elements during locking. In some drawer cabinets with a blocking system, there are also cases where two drawers are opened when pulled at the same time.

In the cabinets currently used, a new locking system and a new pitch are constantly being worked on for each drawer cabinet. While this is an obstacle for mass production, trying to solve a new system each time reduces quality. In some products, the use of thick sheet metal and heavy materials to make the locking elements durable increases the weight and cost of the product.

In the state of the art, TR2021/015316 relates to a locking mechanism used in drawer cabinets. With the locking mechanism disclosed in this document, it is aimed to increase the robustness of the drawer in forcing the drawer to open after the locking process of cabinets with wide drawers, to provide easy locking and easy drawer movement in heavy drawers, and to provide easy use by taking the right-left play of the drawer and increasing the locking security. However, this document does not mention a structure that allows one of the drawers to remain open while the others remain locked.

Document number CN201933898U relates to a cabinet with a multi-drawer locking mechanism. In the said cabinet, the drawers comprise a limiting mechanism and the drawers correspond to this limiting mechanism. However, this document does not mention a structure that allows one of the drawers to remain open while the others remain locked.

As a result, improvements are being made to the locking mechanisms in drawer cabinets, therefore new structures are needed that will eliminate the disadvantages mentioned above and provide solutions to existing systems.

### SUMMARY

The present invention relates to multi-drawer cabinet locking mechanism which fulfils the abovementioned requirements, eliminates all disadvantages and brings some additional advantages.

The main object of the present invention is to provide a locking mechanism that prevents the opening of the other drawers when one of the drawers is open in cabinets having a plurality of drawers in a row.

One object of the present invention is to provide a locking mechanism that is lighter, offers a long service life, operates more quietly and can be produced more cost-effectively.

Another object of the present invention is to develop a structure suitable for working in a certain pitch size range and to provide a locking system that can be applied to drawer heights of any size.

In order to realize all the advantages mentioned above and to be understood from the detailed description below, the present invention is a cabinet locking mechanism used in cabinets having a plurality of drawers in a row, which ensures that the other drawers above and below are locked when one of the drawers in the same row is open, which has a locking tongue that enables the cabinet to be locked or unlocked from the outside and a locking shaft that transfers the movement received from the lock tongue to the locking mechanism; a structure is obtained comprising;

bearing plate, on which the locking mechanism is installed and which provides the connection of the locking mechanism to the cabinet, extends along the height of the cabinet to meet each drawer,

locking and guiding element, which is connected to the bearing plate and enables the locking system to be opened or closed with the movement coming from the locking shaft,

drawer lock plate, which is located at the back of each drawer on the cabinet and allows the drawer to be locked,

locking latch, which is connected to each drawer on the bearing plate and provides locking by coming into contact with the drawer lock plate,

blocking plate, which is positioned along the bearing plate on the bearing plate and enables the locking mechanism to operate when one of the drawers is opened,

blocking buffer consisting of an upper buffer and a lower buffer, which is positioned opposite each drawer on the blocking plate and restricts the movement of the locking latch that locks the drawer.

The structural and characteristic features of the present invention will be understood clearly by the following drawings and the detailed description made with reference to these drawings. Therefore the evaluation shall be made by taking these figures and the detailed description into consideration.

### BRIEF DESCRIPTION OF THE DRAWINGS

In order to understand the advantages of the present invention with its structure and additional elements, it shall be evaluated with the following defined figures.

FIG. 1 is a general view of the locking mechanism of the present invention.

FIG. 2 is a detailed view of the locking mechanism of the present invention.

FIG. 3 is a detail front view of the locking mechanism of the present invention in a locked state.

FIG. 4 is a perspective detail view of the locking mechanism of the present invention in a locked state.

FIG. 5 is a detail front view of the locking mechanism of the present invention in an unlocked state.

FIG. 6 is a perspective detail view of the locking mechanism of the present invention in an unlocked state.

### Reference Numbers

1. Lock tongue

2. Locking shaft

3. Motion transmission bar

4. Drawer lock plate

5. Bearing plate

6. Locking and guiding element

7. Locking latch

8. Blocking buffer

8.1 Upper buffer

8.2. Lower buffer

9. Blocking plate

10. First drawer

11. Second drawer

### DETAILED DESCRIPTION OF THE EMBODIMENTS

In this detailed description, the preferred embodiments of the locking mechanism of the present invention is described only for clarifying the subject matter in a manner such that no limiting effect is created.

The present invention is a cabinet locking mechanism used in cabinets having a plurality of drawers in a row, which ensures that the other drawers above and below are locked when one of the drawers in the same row is open, which has a locking tongue (1) that enables the cabinet to be locked or unlocked from the outside and a locking shaft (2) that transfers the movement received from the lock tongue (1) to the locking mechanism, comprising;

bearing plate (5), on which the locking mechanism is installed and which provides the connection of the locking mechanism to the cabinet, extends along the height of the cabinet to meet each drawer,

locking and guiding element (6), which is connected to the bearing plate (5) and enables the locking system to be opened or closed with the movement coming from the locking shaft (2),

drawer lock plate (4), which is located at the back of each drawer on the cabinet and allows the drawer to be locked,

locking latch (7), which is connected to each drawer on the bearing plate (5) and provides locking by coming into contact with the drawer lock plate (4),

blocking plate (9), which is positioned along the bearing plate (5) on the bearing plate (5) and enables the locking mechanism to operate when one of the drawers is opened,

blocking buffer (8) consisting of an upper buffer (8.1) and a lower buffer (8.2), which is positioned opposite each drawer on the blocking plate (9) and restricts the movement of the locking latch (7) that locks the drawer.

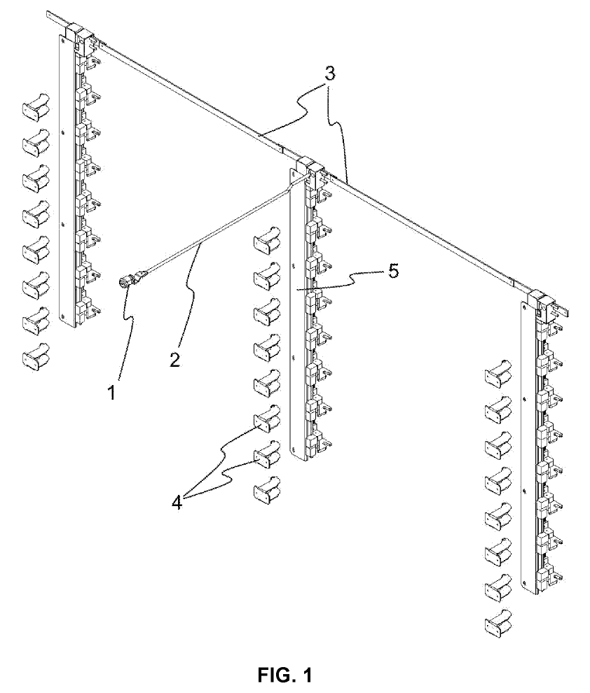

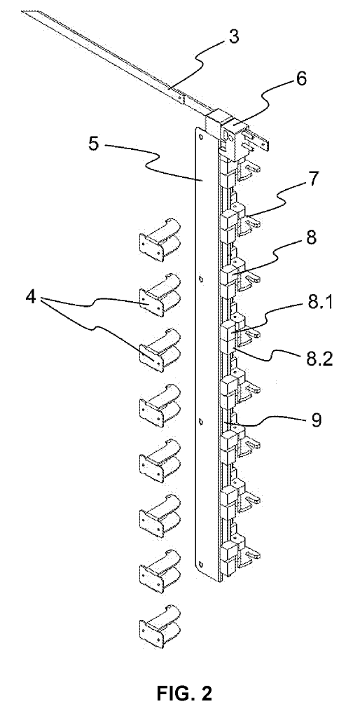

FIG. 1 and FIG. 2 show the general and detailed views of the cabinet locking mechanism which is the subject of the invention. In the mentioned cabinet locking mechanism, the opening and locking of the locking system is provided by a locking latch (1) located on the cabinet and the locking shaft (2) connected to the locking latch (1). The locking mechanism is connected to the cabinet via a bearing plate (5). The bearing plate (5) extends to the height of the cabinet to meet each drawer according to the number of drawers in the cabinet. The locking shaft (2) is connected to the locking and guiding element (6) located on the upper part of the bearing plate (5). The locking and guiding element (6) ensures both the operation of the locking mechanism and the distribution of the locking movement to the entire locking system in systems with multiple drawers side by side. The locking and guiding element (6) is connected to the blocking plate (9) that extends along the bearing plate (5) on the bearing plate (5). The locking and guiding element (6), which opens when the locking system is opened, releases the blocking plate (9) and allows any drawer in the system to be opened. The drawers are connected to the locking latches (7) located on the bearing plate (5) in the locking system by means of the locking plates (4) located behind them. The locking latches (7) are positioned on the bearing plate (5) to correspond to each drawer. The movement of the locking latches (7) is restricted by means of blocking buffers (8) positioned on the blocking plate (9) and located separately in front of each locking latches (7). The blocking buffers (8) mentioned consist of an upper buffer (8.1) and a lower buffer (8.2). The locking latch (7) enters between the upper buffer (8.1) and the lower buffer (8.2) when the drawer is pulled, and the drawer is opened by the locking latch (7) releasing the locking plate (4). In case any drawer in the locking system is opened, the blocking plate (9) locks the system and prevents the locking latches (7) from getting in between the blocking buffer (8) when the other drawers are pulled, preventing the drawers from being opened. In this way, while a drawer is open in the locking system, the other drawers are prevented from being opened.

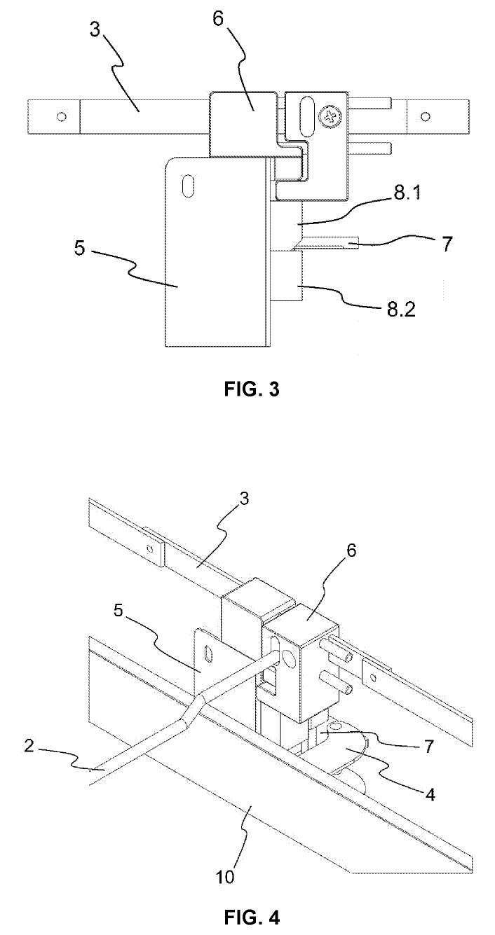

FIG. 3 and FIG. 4 show a representative view of the locking system when it is locked. In this case, the locking and guiding element (6) locks the blocking plate (9) and restricts the movement of the buffers (8). In this case, even if the first drawer (10) is pulled, the locking latch (7) corresponding to the locking plate (4) of the first drawer (10) cannot enter between the upper buffer (8.1) and the lower buffer (8.2) and does not release the locking plate (4). In this case, the drawers on the cabinet cannot be opened.

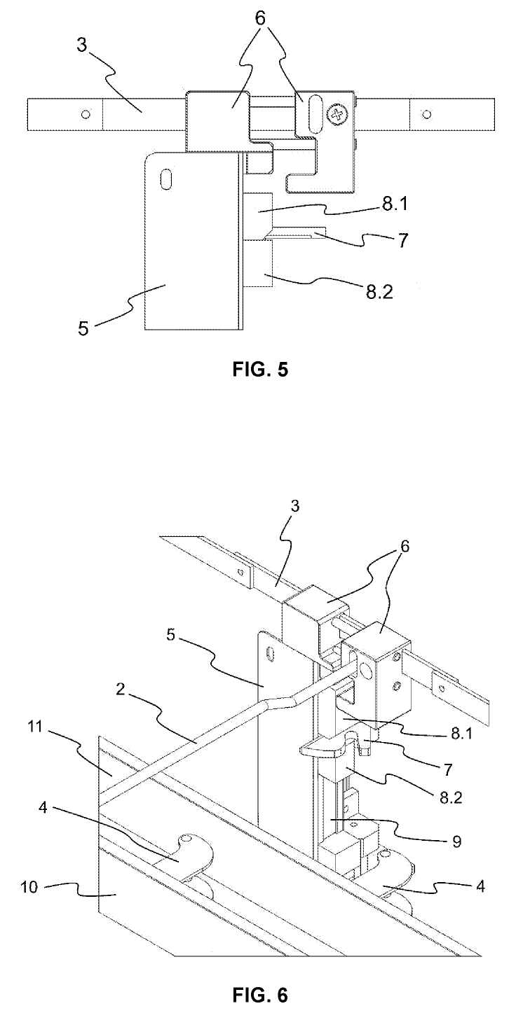

FIG. 5 and FIG. 6 show a representative view of the locking system when it is unlocked. In this case, the locking and guiding element (6) releases the blocking plate (9) and the movement of the buffers (8) can be ensured. In this case, when the first drawer (10) is pulled, the locking latch (7) corresponding to the locking plate (4) of the first drawer (10) enters between the upper buffer (8.1) and the lower buffer (8.2) and releases the locking plate (4). Thus, the first drawer (10) is opened. However, in this case, the blocking plate (9) locks the system and restricts the movement of the other buffers (8). In this case, when a second drawer (11) is pulled out, the locking latch (7) corresponding to the locking plate (4) of the second drawer (11) cannot enter between the buffers (8) and does not release the locking plate (4) of the second drawer.

In cabinets with more than one drawer side by side, there are motion transmission bars (3) on the locking and guiding element (6) to ensure that the movement of the locking system is distributed throughout the entire system. The mentioned motion transmission bars (3) transfer the movement of the locking and guiding element (6) to the other locking and guiding elements (6) and ensure that the locking system works in the same way for each row of drawers on top of each other.

The lightweight of the system is ensured by the predominant use of plastic and aluminum materials in the cabinet lock mechanism which is the subject of the invention. These materials can be printed using plastic injection or they can be printed using light metals in a mold to ensure longer life. While keeping the number of parts used to a minimum, the plate materials used in the system were preferred as “u” bent galvanized sheet metal. The mentioned plate materials are placed between the locking elements in the system by adjusting them to the required dimensions. In this way, the locking mechanism is made compatible with all sizes.

What is claimed is:

1. A cabinet locking mechanism used in cabinets having a plurality of drawers in a row, wherein when one of the drawers in the same row is open, the cabinet locking mechanism is configured to lock the other drawers above and below, and the cabinet locking mechanism comprises:
a locking tongue, wherein the locking tongue enables the cabinet to be locked or unlocked from the outside,
a locking shaft, wherein the locking shaft transfers a movement received from the lock tongue to the cabinet locking mechanism,
a bearing plate, wherein the cabinet locking mechanism is installed on the bearing plate and the bearing plate provides a connection of the cabinet locking mechanism to a cabinet, and extends along a height of the cabinet to meet each drawer,
a locking and guiding element, wherein the locking and guiding element is connected to the bearing plate and enables the cabinet locking mechanism to be opened or closed with a movement coming from the locking shaft,
a drawer lock plate, wherein the drawer lock plate is located at a back of each drawer on the cabinet and allows the drawer to be locked,
a locking latch, wherein the locking latch is connected to each drawer on the bearing plate and provides locking by coming into contact with the drawer lock plate,
a blocking plate, wherein the blocking plate is positioned along the bearing plate on the bearing plate and enables the cabinet locking mechanism to operate when one of the drawers is opened, and
a blocking buffer consisting of an upper buffer and a lower buffer, wherein the blocking buffer is positioned opposite each drawer on the blocking plate and restricts a movement of the locking latch for locking the drawer.

2. The cabinet locking mechanism according to claim 1, further comprising a motion transmission bar connected to the locking and guiding element, wherein the motion transmission bar allows a locking motion to be distributed to the cabinet locking mechanism in cabinet locking systems with multiple drawers side by side.
